(19) United States
(12) Patent Application Publication
(10) Pub. No.: US 2007/0297813 A1
(43) Pub. Date: Dec. 27, 2007

(54) Optical Receiving Device

(75) Inventors: Norikazu Urata, Singapore (SG); Chuan Wai Wong, Singapore (SG)

Correspondence Address: DICKSTEIN SHAPIRO LLP, 1825 EYE STREET NW, Washington, DC, 20006-5403, US

(73) Assignee: OLYMPUS TECHNOLOGIES SINGAPORE PTE LTD., Singapore (SG)

(21) Appl. No.: 11/663,507

(22) PCT Filed: Oct. 7, 2005
(86) PCT No.: PCT/SG05/00347

§ 371 Date: Mar. 22, 2007

(30) Foreign Application Priority Data
Oct. 8, 2004 (SG) 200405928.3

(51) Int. Cl. H04B 10/06

(52) U.S. Cl. 398/212; 398/202

(57) ABSTRACT

An optical receiving device for receiving an optical signal (60) from a signal collector (50) comprising a detector (40) for receiving the optical signal (60) form the collector (50) and a signal mask (45) having an aperture (47) through which at least a portion of the signal (65) passes, said mask (45) located along an optical axis (66) of the signal intermediate the collector (50) and the detector (40) wherein the location of the signal mask (45) is such so as the attenuate the signal (65) to less than a saturation threshold of the detector (40) and a conjugate image plane (70a) of the signal (65) is located within a range form coincident with the mask (45) to intermediate the mask (45) and detector (40).

### FIELD OF THE INVENTION

The invention relates to optical receiving devices used to receive an optical signal, and in particular, receiving devices applicable to at least laser scanning systems, scanning microscopes, barcode scanners, photocopiers and infrared communication devices.

### BACKGROUND OF THE INVENTION

Optical receiving devices are used to receive an optical signal for conversion to a digital signal for the communication of data. Examples of devices using optical receiving devices include laser scanning systems, scanning microscopes, barcode readers, optical pick up, remote control devices, camera modules, infrared communication devices, airborne line scanning systems and photocopy systems.

The optical receiving device is designed so as to be active in a range from a minimum threshold to a maximum threshold of the detector, such as a photo detector, photo multiplier, infrared detector.

The minimum threshold may be determined by certain operational parameters. For instance, the minimum threshold may be set to a minimum allowable signal level. Alternatively, the minimum threshold may be the level below which the reliability of data from the detector is unacceptable.

Typically, the maximum threshold will be determined by the point at which the detector undergoes signal saturation. Above saturation, variations in data may be indistinguishable leading to an incorrect action of the circuit, or possibly damage caused to the detector as the capacity of the detector is exceeded.

FIG. 1 shows a typical characteristic of an optical receiving device showing signal strength as a function of target distance for a barcode scanner. Similar characteristics can be generated for optical receiving device for other purposes.

From the characteristic the upper and lower limits define the operational range. This range is identified by the curvi-linear characteristic varying from a maximum threshold at near field to a minimum threshold at far field. In designing an optical receiving device for a certain application, the desired range of application is determined and a suitable detector selected on the basis of the minimum and maximum thresholds proximate to the intended near and far field.

If the system designer wishes to improve the signal level for the device when the target is at far field, he would need to increase the signal gain of optical system, that is, amplify the signal level. However, in doing so, when the target approaches near field, the normal operating range will exceed saturation threshold level for the detector. Consequently, the device loses its effective range at near field. Alternatively, the designer may compromise the effectiveness of the device to maintain an acceptable operational range within the limitations of the upper and lower thresholds.

As a further alternative, a smaller detector or small aperture on the detector could be selected. The smaller detector can improve above saturation issue and reduce the optical noise level too, however, such a detector will yield poor efficiency, leading to a lower intensity (signal level) at far field, and consequently, a reduced signal level. Further, with the inherent difficulties associated with positioning any type of detector within a printed circuit board (PCB) assembly, these are exacerbated for a smaller detector.

In light of these limitations it is an object of the present invention to be able to increase signal gain for an optical receiving device without compromising the range for which the optical receiving device is applied.

### SUMMARY OF INVENTION

With this object in mind in a first aspect, the invention provides an optical receiving device for receiving an optical signal from a signal collector comprising a detector for receiving the optical signal from the collector and a signal mask having an aperture through which at least a portion of the signal passes, said mask located along an optical axis of the signal intermediate the collector and the detector wherein the location of the signal mask is such so as to attenuate the signal to less than a saturation threshold of the detector and a conjugate image plane of the signal is located within a range from coincident with the mask to intermediate the mask and detector.

Thus, the present invention adds flexibility for adjusting the signal characteristic within the upper and lower limits, by attenuating the signal at the near field end of the optical receiving device range to substantially less than saturation, and so permit the designer to increase the signal level at far field.

A further advantage offered by the present invention relates to the mask acting as a physical screen. As a result, the device of the present invention does not require protective systems to protect the detector from saturation. In prior art devices for a rapidly increasing signal, the response time of a protective system may be insufficient to prevent damage to the detector. Being a physical barrier, attenuation of the signal by the mask is instantaneous, and therefore eliminates this risk.

Further still, the present invention offers the ability to stabilize the level of light received by the detector, through greater control of light passing the mask.

In a preferred embodiment, the aperture size of the mask may be smaller than the area of the detector. If the optical filter is placed proximate the aperture, rather than the detector, the filter size may be reduced. As the cost of the device may be driven by material costs, the invention may provide the added benefit of reducing the overall cost of the device.

This may also permit a wide selection of size and layout of the detector, as the detector can be placed at any point passed the mask. Beyond the conjugate image plane, the signal will accordingly grow in size. A detector of a particular size may be placed at any point thereafter for the purpose of fitting the detector to precisely the correct beam size of signal, in order to maximize the usage of the effective area of the detector.

Alternatively, if the placement of the detector is to be at a fixed distance, say, for a known device, the beam size at the relevant point may be determined, and a suitable detector selected for the application.

At far field, the image plane is located at the mask position, which correspondingly, will also be the location of the minimum beam size for the signal. In the present invention, the detector is separated from mask and the beam size increases after passing through aperture hole, eventually, project on detector with larger beam size. The large beam size covers the whole effective area of detector and fully utilizes the area. This may have the benefit of reducing the effect of localized defects of the detector, including dust, scratches, dirt, glue residue and etc. This will have the further effect of reducing optical noise and other noise substantially. Thus, S/N ratio is improved.

As to manufacturing cost, the mask may replace the aperture associated with the detector. In a typical arrangement, the aperture and detector are proximate, and normally bonded to each other. At the scale of the device for use with a PCB assembly, the degree of difficulty in aligning the aperture and detector is significant. For the present invention, having the aperture as a separate element from the detector permits the alignment to be performed, not by the bonding of the aperture and detector, but as a part of the basic device. Thus, where the device may include an injection molded housing, the aperture and detector may be mounted in the housing with a high degree of precision with relative ease. Therefore, the cost of production is reduced, whilst still maintaining a high level of quality.

Further still, as there is a gap between the optical filter, which may be proximate the mask, and the detector, may help avoid glue out-gassing on the detector surface during device.

In a preferred embodiment, the noise level may be further reduced through reduction in stray light without sacrifice of signal level (S). The use of the mask at a distance from the detector, reduces the angular range into which the signal may be both projected through the aperture and received by the detector.

This is distinct from the prior art where any light passing through the aperture will be received by the detector. Consequently, stray light entering at a range of different angles will only interfere with the detector within that angular range (field of view, FOV). Because of the reduced range, noise level (N) resulting from stray light will equally be reduced, therefore, S/N ratio will be increased.

In a preferred embodiment, the device may function as an automatic optical gain correction device, that may automatically adjust signal gain based on certain parameters, such as the signal level being below an acceptable level.

In a preferred embodiment, the mask may be any one of a fixed aperture, an adjustable aperture, aperture disc, a stop, a shutter, a hole, a coated substrate or an optical band pass filter.

In a second aspect, the present invention provides an optical receiving device for receiving an optical signal from a signal collector comprising a detector for receiving the optical signal from the collector and a signal mask having an aperture through which at least a portion of the signal passes, said mask is spaced from the detector along an optical axis of the signal intermediate the collector and the detector wherein the location of the signal mask is such so as to attenuate the signal to less than a saturation threshold of the detector.

In a third aspect, the present invention provides a method of attenuating a signal received by an optical receiving device from a signal collector, the method comprising the steps of:

positioning a mask intermediate the collector and detector along an optical path of the signal such that a conjugate image plane of the signal is located within a range from coincident with the mask to intermediate the mask and detector;

moving a target, from which the signal is projected, progressively towards the detector from far field to near field;

masking the signal passing through the mask when the target reaches an attenuation point intermediate far field and near field, and;

attenuating the signal, from the attenuation point, to less than a saturation threshold of the detector.

### BRIEF DESCRIPTION OF DRAWINGS

FIG. 1 is a characteristic of an optical receiving device of the prior art;

FIGS. 2a to 2e are schematic views of the optical receiving device according to the present invention, as the target moves progressively closer to the detector;

FIG. 3 is a characteristic of the optical receiving device of FIGS. 2a to 2e;

FIG. 4a is a schematic view of one optical receiving device of the prior art;

FIG. 4b is a schematic view of another optical receiving device of the prior art;

FIG. 4c is a schematic view of the optical receiving device according to an embodiment of the present invention;

FIG. 5 is a schematic view of an optical system incorporating an optical receiving device according to the present invention;

FIG. 6a is an isometric view of one embodiment of the present invention;

FIG. 6b is a sectional view of the embodiment of FIG. 6a.

FIG. 7 is a further schematic view of an optical receiving device according to the present invention.

### DESCRIPTION OF PREFERRED EMBODIMENT

It will be convenient to further describe the present invention with respect to the accompanying drawings which illustrate possible arrangements of the invention. Other arrangements of the invention are possible, and consequently the particularity of the accompanying drawings is not to be understood as superseding the generality of the preceding description of the invention.

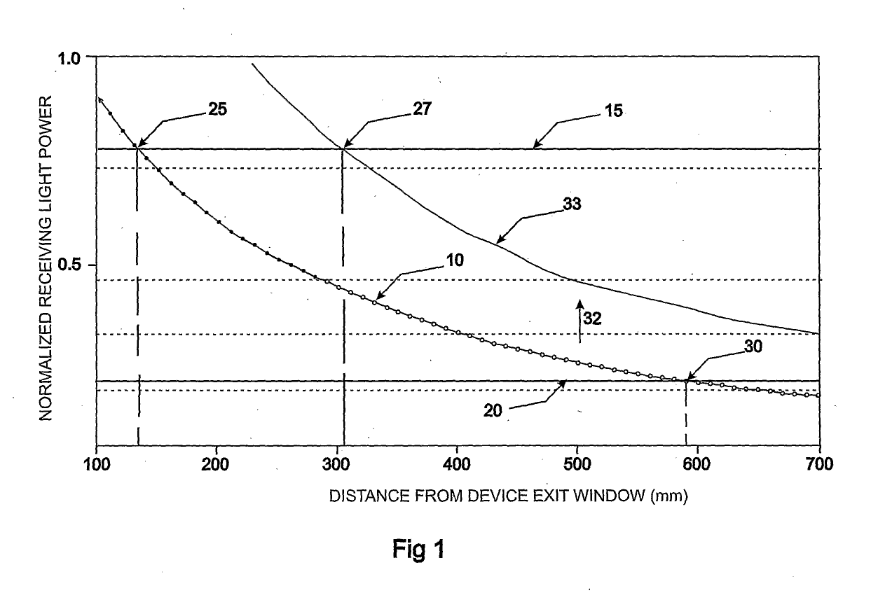

FIG. 1 shows a characteristic 10 of an optical receiving device of the prior art. In this case, the optical receiving device has been adapted for use with a laser scanning system and so the characteristic measures received light as a function of distance from the device exit window to the target being information media such as barcode. The operating signal range of the device is limited within the maximum threshold 15 representing saturation of the detector and a minimum threshold 20 represented by the lowest acceptable signal level for said detector. Mapping the characteristic 10 within the maximum threshold 15 and minimum threshold 20 defines the acceptable operating distance for the device from near field 25 to far field 30. If, as a result of a change of operational parameters, the designer may wish to increase the signal gain for the device, this would have the effect of shifting 32 the characteristic 10 upwards to a new characteristic 33 proportionally. Whilst improving the signal level at far field the corresponding effect is to shorten the available operating distance to a new near field limit 27. Thus, the action of increasing signal gain has the corresponding effect of reducing the operational range of the device.

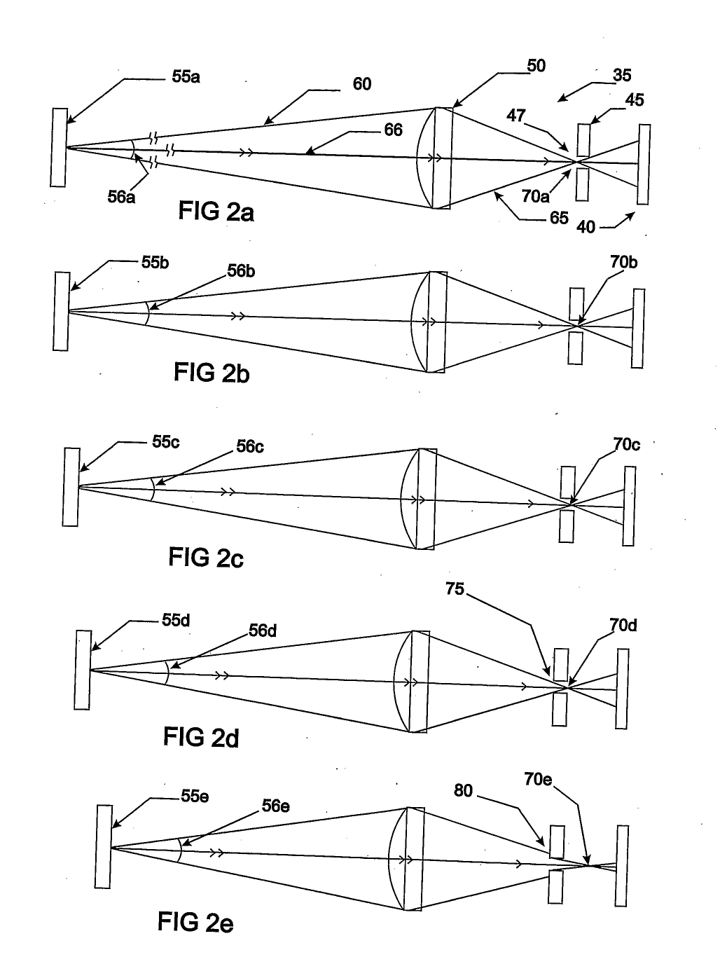

FIGS. 2a to 2e show various schematic views of a device according to the present invention. In this arrangement is located a detector 40, a mask 45 having an aperture 47 and a collector, in this case, a lens 50. A signal 60 is projected from a target 55a to e along an optical axis 66, passing through the device to the detector.

In FIG. 2a, a target 55a at an extreme distance projects an optical signal 60 to the lens 50 which, given the distance from the target 55a, receives the light at a very narrow divergence angle 56a. The lens 50 consequently directs the signal 65 through the aperture 47 of the mask 45 onto the detector 40. At far field the directed signal 65 creates a conjugate image plane 70a within or just forward of the mask 45. In this arrangement the full signal is directed to the detector 40.

In FIG. 2b, the target 55b is placed at the design far field whereby the projected signal 65 creates a conjugate plane 70b directly within the aperture 47 of the mask 45. At this distance, the divergence angle 56b of the light received by the lens 50 from the target 55b is marginally greater, and so the received light power is also greater. FIG. 2c shows the target 55c within the operational range. It should be noted that as the target 55c approaches the lens 50, the conjugate image plane 70c moves towards the detector 40 and so bringing the directed signal 65 proximate to the periphery of the aperture 47.

FIG. 2d represents the target 55d at a predetermined location whereby the mask begins to interfere with the directed signal 65. Here, the conjugate image plane 70d has clearly emerged from the mask, progressing toward the detector 40. From this point, FIG. 2e shows the target 55e progressively approaching the lens, with a corresponding shift of the conjugate image plane 70e toward the detector, leading to the directed signal 65 being progressively masked 80 and so reducing the signal received by the detector 40.

In progressing the target from an intermediate position 55c to imminent masking 55d and then approaching near field 55e, the divergence angle of light from the target also increases progressively 56c to 56e, as does the light power received by the detector 40.

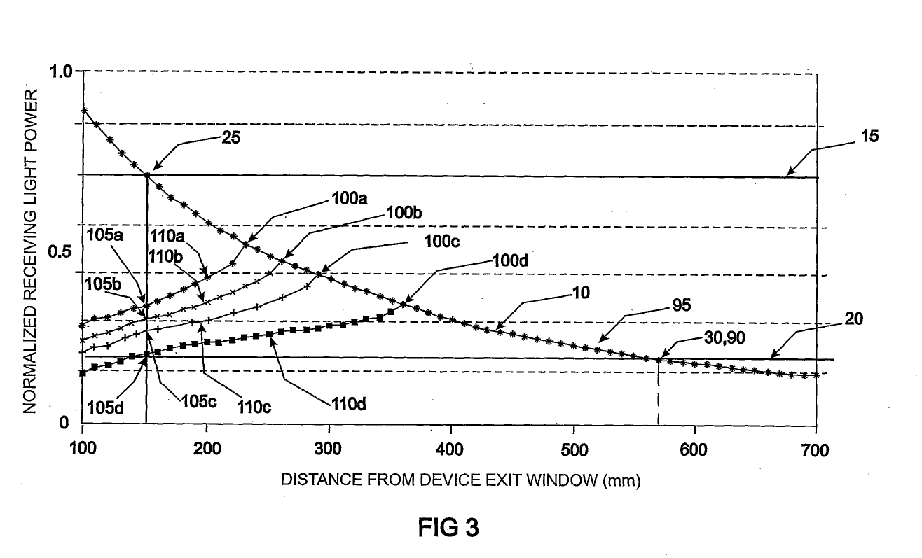

FIG. 3 shows a characteristic of the optical receiving device 35 according to the present invention. For the same parameters which derive the characteristic of FIG. 1, the base characteristic 10 of the optical receiving device 35 remains identical at the far field end of the characteristic. It follows that, the maximum threshold 15 and minimum threshold 20 are also the same as for the previous characteristic and so a comparison of the effect of the present invention can be made. The various positions of the target 55a to c are identical to that of the prior art and form points along the characteristic 90, 95. The target 55d is positioned such that the directed signal 65 is subject to imminent interference by the aperture, which corresponds to a point of divergence 100a to d from the characteristic of the prior art. The point of divergence will vary with aperture size, from the largest 100a to the smallest 100d. As the target 55e progressively approaches the lens 50, the directed signal 65 is masked 80 and so creating a diverging characteristic 110a to d.

The effect of the present invention is to create a maximum received signal 100a to d which is significantly less than the maximum threshold 15. Thus, the designer is free to increase signal gain without exceeding the maximum threshold. This is demonstrated by the flatter profile of the new characteristic 110a to d leading to significantly greater flexibility to manipulate signal gain than is available for a device of the prior art. In contrast to the invention, the near field limit 25 of the device of the prior art defines the maximum signal strength permitted by the device. Conversely, the near field position of a device according to the present invention, in fact, approaches the minimum threshold 20 rather than the maximum threshold 15. A comparison of the characteristic 110a to d of the present invention and that of the prior art 10, shows that at the point at which the device of the prior art reaches saturation 25, the signal of the present invention at the same distance 105a to d is significantly less, and certainly not an upper limit of the useful range of the device.

Thus, an increase in signal gain will in fact benefit the near field position to the same extent that it will benefit the far field position.

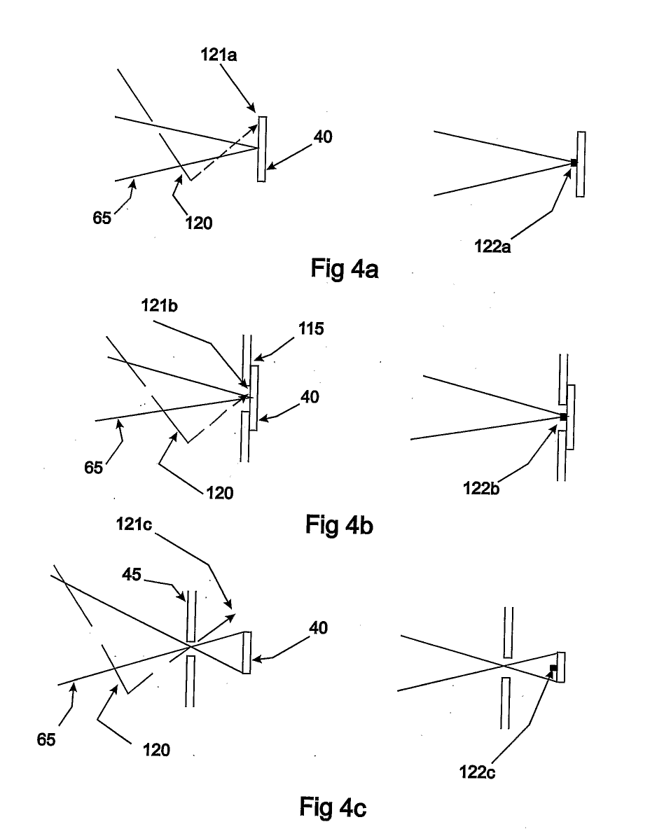

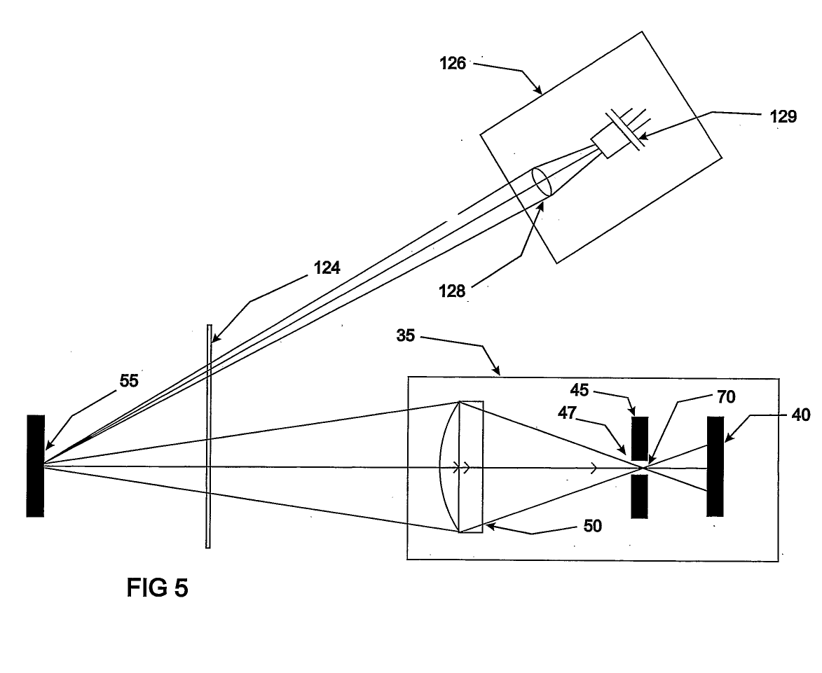

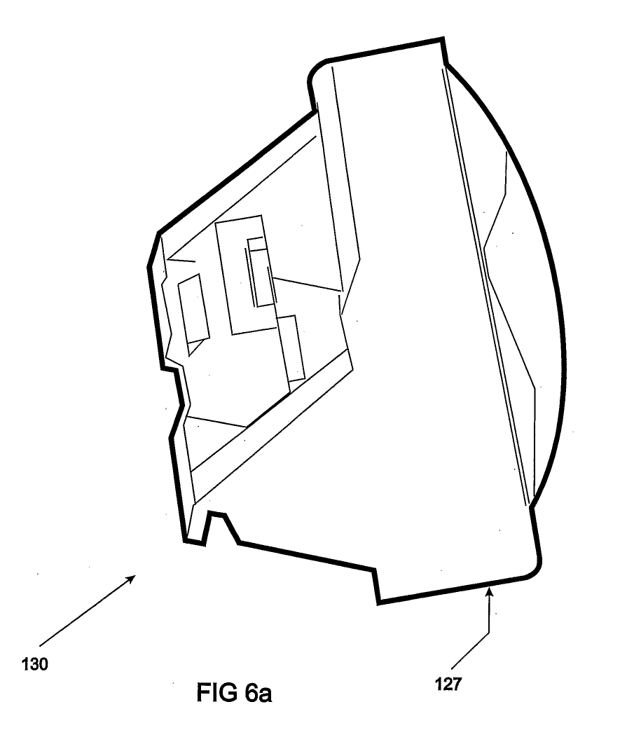

FIG. 4a to c show the effect of the separated mask/detector, in terms of noise reduction, as compared to the prior art. FIGS. 4a and 4b show two alternative arrangements of the prior art, both with and without an aperture.

FIG. 4a shows the case without an aperture whereby stray light 120 can reflect from surrounding surfaces to impact the detector 121a. Further, as the beam size on impact with the detector is small, any scratch, dust or other defect 122a located on the detector at the point of impact, will adversely affect the signal. In FIG. 4b, the prior art case where an aperture is used is materially the same as FIG. 4a, in that the aperture merely blocks peripheral portions of the detector. Stray light 120 is still able to impact the detector 121b, and the beam size at the detector is still small, and so defects 122b at the image point will still create significant noise.

FIG. 4c shows the arrangement according to the present invention. Having the aperture separated from the detector 40 decreases the angle (FOV) at which the directed signal 65 may be received by the detector. Thus, stray light 120 which falls outside this reduced FOV will not be received 121c by the detector with the effect that for a change in arrangement the level of noise generated by stray light is reduced without sacrificing of signal level.

Similarly, the separation of the mask and detector, leads to an increased beam size at the detector. Thus, a defect 122c of the type shown in FIGS. 4a and 4b will have a much reduced impact on the total signal. Thus, this combination of separation and reduced FOV lead to a significantly increased S/N for the same conditions as compared to the prior art.

FIG. 5 shows a schematic of an optical system, including an output optics device 126, having a laser source 129 and a focusing lens 128, scanning device 124 through which light is directed onto a target 55, and correspondingly received from the target 55. The light reflected from the target 55 and through the scanning device 124, is then directed to a receiving optical device 35 according to the present invention.

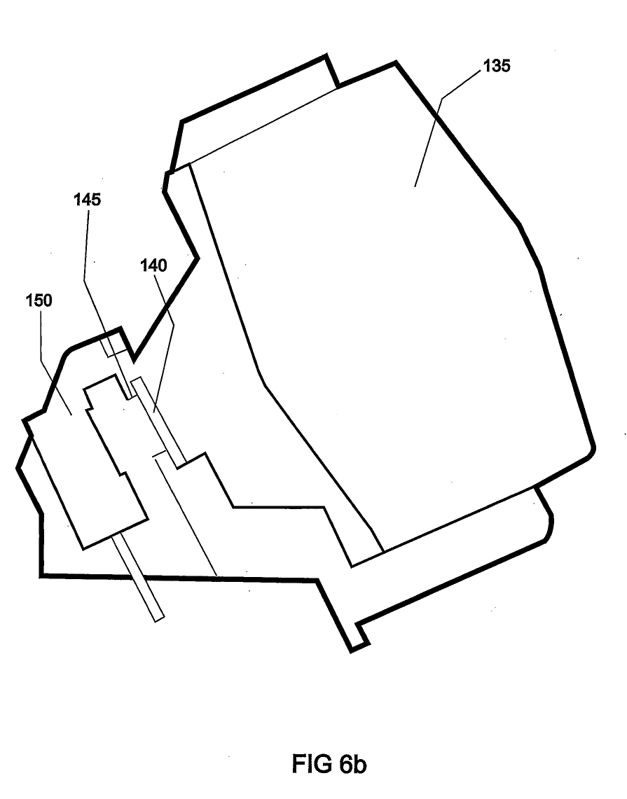

FIGS. 6a and 6b show a particular embodiment of the present invention. The optical receiving device 130 further includes a housing 127 manufactured through injection molding. Where a placement of an aperture in relation to a detector of the prior art required the aperture to be bonded to the detector, with the present invention this very precise and difficult process is avoided by mounting the detector 150 only within the housing where the aperture 145 is already part of the housing. Further, an optical filter 140 is placed proximate the aperture, which, with the other elements is along an optical axis from the projected signal directed from the lens 135.

Rather than the precision required for manufacture residing in the placement and bonding of the aperture to the detector, the present invention maintains this precision through a much simpler and more controllable process of injection molding. Thus, in addition to the aforementioned advantages, the present invention also has significant advantage in ease, and therefore cost, of manufacture.

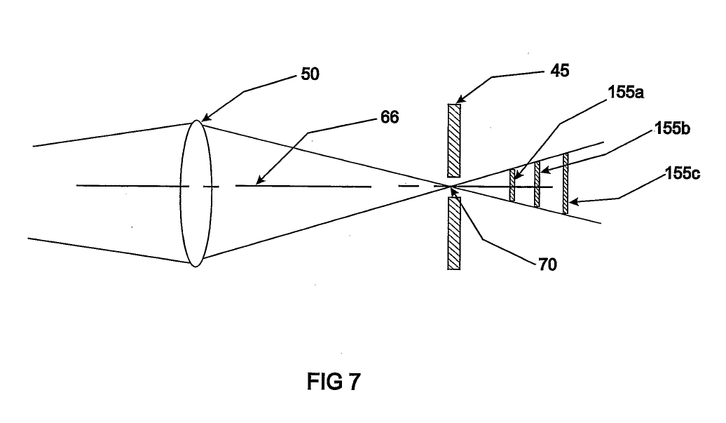

FIG. 7 shows a further advantage of the present invention. As discussed, the separation of the mask 45 from the detector 155a to c leads to the beam size at the detector to be larger than compared to the prior art. It follows that this beam size will vary with the distance from the mask. Therefore, the scope to maximize the effective area of the detector is increased, as demonstrated in two examples.

For a detector 155a of known size, the distance from the mask for a corresponding the beam size can be calculated, and the device of the present invention constructed based on this size and distance.

Alternatively, for a predetermined device size, and therefore a fixed distance at which the detector can be placed, and the beam size at that point can be calculated, and a detector 155a to c matching this size selected. The prior art offers no such advantage, either with or without the use of an aperture.

### EXAMPLES

In demonstrating efficacy of the invention to arrangements of the components are provided for various conditions. These are provided in Table 1.

TABLE 1
Summary of Working Examples

| | Working Example 1 | Working Example 2 |
|---|---|---|
| Lens thickness | 20.0 mm | 8.0 mm |
| Distance from lens to aperture | 63.0 mm | 5.5 mm |
| Thickness of optical filter | — | 0.55 mm |
| Distance from aperture to | 4.0 mm | 1.15 mm |
| photo detector | | |
| Focal length of lens | 77.7 mm | 15.0 mm |
| Dimension of aperture | Diameter: 3.2 mm | Diameter: 3.2 mm |
| Dimension of detector | Diameter: 5.0 mm | Height: 3.3 mm |
| | | Width: 4.0 mm |

1. An optical receiving device for receiving an optical signal from a signal collector comprising a detector for receiving the optical signal from the collector and a signal mask having an aperture through which at least a portion of the signal passes, said mask located along an optical axis of the signal intermediate the collector and the detector wherein the location of the signal mask is such so as to attenuate the signal to less than a saturation threshold of the detector and a conjugate image plane of the signal is located within a range from coincident with the mask to intermediate the mask and detector.

2. The device according to claim 1, wherein the signal is directed from a target before reaching the collector.

3. The device according to claim 2 wherein the conjugate image plane of the signal is coincident with the mask when the target is at far field.

4. The device according to claim 1, wherein the aperture is smaller in area than the detector.

5. The device according to claim 4 wherein a dimension of the mask in any one cross sectional plane is less than or equal to an equivalent dimension of detector in the same cross sectional plane.

6. The device according to claim 1 further comprising an optical filter located proximate the mask and distal from the detector, such that the signal passing through the aperture also passes through the filter.

7. The device according to claim 1, further comprising an automatic optical gain correction device for adjusting signal gain based on predetermined parameters, said parameters comprising one or a combination of allowable signal level and saturation of the detector.

8. The device according to claim 1, wherein the collector includes at least one or a combination of at least one lens and a mirror.

9. The device according to claim 1, wherein the device is adapted for use as the optical receiving system of a laser scanning system, a barcode scanner, a photocopier, a scanning microscope, an optical pick up, a remote control device, a camera module, an infrared communication device or an airborne line scanning system.

10. The device according to claim 2, wherein the target is a barcode.

11. The device according to claim 1, wherein said device is constructed as a unitary element.

12. The device according to claim 1, further comprising a housing wherein the collector, mask and detector are mounted to said housing.

13. The device according to claim 1, further comprising a housing wherein the collector, mask and detector are integral with said housing.

14. The device according to claim 12 wherein the housing is injected molded as a single part. than the distance from the collector to the conjugate image plane within an operational range of the device.

16. The device according to claim 1, wherein the distance from the collector to the conjugate image plane within an operational range of the device is less than the distance from the collector to the detector.

17. The device according to claim 1, wherein the mask is any one of a fixed aperture, an adjustable aperture, aperture disc, a stop, a shutter, a hole, a coated substrate or an optical band pass filter.

18. The device according to claim 1, wherein the mask is spaced from the detector.

19. An optical receiving device for receiving an optical signal from a signal collector comprising a detector for receiving the optical signal from the collector and a signal mask having an aperture through which at least a portion of the signal passes, said mask is spaced from the detector along an optical axis of the signal intermediate the collector and the detector wherein the location of the signal mask is such so as to attenuate the signal to less than a saturation threshold of the detector.

20. The device according to claim 19 wherein a conjugate image plane of the signal is located within a range from coincident with the mask to intermediate the mask and detector.

21. A method of attenuating a signal received by an optical receiving device from a signal collector, the method comprising the steps of:
positioning a mask intermediate the collector and detector along an optical path of the signal such that a conjugate image plane of the signal is located within a range from coincident with the mask to intermediate the mask and detector;
moving a target, from which the signal is projected, progressively towards the detector from far field to near field;
masking the signal passing through the mask when the target reaches an attenuation point intermediate far field and near field, and
attenuating the signal, from the attenuation point, to less than a saturation threshold of the detector.

22. (canceled)

23. (canceled)
